(19) United States
(12) Patent Application Publication
(10) Pub. No.: US 2017/0129210 A1
(43) Pub. Date: May 11, 2017

(54) MULTILAYER TEXTILE MATERIAL AND PRODUCTS MADE WITH IT

(71) Applicant: GOOSE TECH S.R.L., Milano (IT)

(72) Inventor: Riccardo BARLOTTI, Milano (IT)

(21) Appl. No.: 15/300,127

(22) PCT Filed: Jun. 17, 2014
(86) PCT No.: PCT/IB2014/062284

§ 371 Date: Sep. 28, 2016

(30) Foreign Application Priority Data
Apr. 1, 2014 (IT) MI2014A000578

(51) Int. Cl. B32B 9/02; B32B 5/02; B32B 27/40; A41D 27/10; A45C 3/00; A45C 3/06; A41D 31/02; A41D 3/02; B32B 9/04; A45C 11/00

(52) U.S. Cl. CPC B32B 9/02; B32B 9/045; B32B 5/02; B32B 27/40; B32B 9/047; A45C 11/00; A45C 3/001; A45C 3/06; A41D 31/02; A41D 3/02; A41D 27/10; B32B 2307/304; B32B 2307/404; B32B 2307/412; B32B 2307/414; B32B 2307/56; B32B 2437/00; B32B 2439/40; B32B 2439/06; A45C 2011/002; A45C 2011/003

(57) ABSTRACT

A multilayer textile material comprising a transparent outer layer, an inner layer and a padding material visible between said two layers, formed by a plurality of elements at least partially having different colours and/or different shades of the same colour; the material is suitable to be used in protective containers for portable electronic devices.

### FIELD OF THE INVENTION

The present invention refers to a multilayer textile material and to the products made with it. More in detail, the invention refers to a textile material comprising a first layer, or outer layer, which is transparent, at least one second layer, or inner layer, and a padding, i.e. filling, material located between said two layers. Examples of products made with said textile material are item of clothing, particularly jackets and coats, in particular the so-called down jackets, i.e. quilted jacket filled with down feathers, purses and handbags, eyeglass cases and computer cases, containers for electronic devices in general and furnishing products and accessories such as cushions and similar. The outer layer is transparent in order to allow the padding, i.e. the filling, to be visible.

### BACKGROUND OF THE INVENTION

Textile material comprising an outer layer, an inner layer and a padding, i.e. filling, material are known for a long time; an example of textile material of this type is that one used for jackets and coats known as “downs” or down jackets, where the padding material is composed of natural or synthetic feathers and down.

Other textile materials with the above mentioned structure are used for quilts, duvets, and covers in general. Now, there is the need of having a textile material that can be used in many different applications both as clothing and as furnishing element, such as cushions or pieces of furniture, or as protective element for fragile objects, in particular portable electronic devices.

Another aim of the invention is to provide a basic textile material that can be suitable to different applications.

### SUMMARY OF THE INVENTION

These aims are achieved by the present invention, that relates to a multilayer textile material, which comprises an outer layer (or first layer), at least one inner layer (or second layer) and a padding material (i.e. a filling material) interposed between said two layers, characterized in that said outer layer is either transparent or translucent and said padding material is formed by a plurality of elements at least partially having different colours and/or different shades of the same colour, said padding material being at least partially visible through said outer layer. The textile material according to the invention then comprises an outer layer (shell layer) that is transparent or translucent and that is the visible layer when the garment is worn or the visible layer of the furniture element or protective element for electronic devices.

The device comprises a second layer that is the inner layer of said item of clothing or furniture element or protective element; this second layer is a down proof layer and, generally, is made of a fabric. The padding is present between the two layers, it preferably is a mixture of natural and/or synthetic feathers and down, it can also come from two or more different sources. Optionally, there can be an additional layer coupled to the down proof layer.

According to a preferred aspect of the invention, the outer layer is a film of transparent material, preferably a film made of transparent or translucent polyurethane. The thickness of the outer layer is preferably lower than, or equal to, 2.0 mm and is anyway selected based on the use function the textile material is intended for; for example, in case of items of clothing, the thickness is comprised between 100 and 200 microns, preferably between 130 and 150 microns (inclusive).

In case of furniture elements, the thickness could rise to about 3-5 mm.

Such materials are known and can be found on the market. Polyurethanes suitable to be used in the invention are aromatic polyethers resistant against hydrolysis, preferably having a Shore A value in the range between 70 and 90, more preferably between 83 and 88, measured according to the standard D2240, and having a melting point not lower than 140° C.

A suitable polyurethane material has a tensile strength comprised between 400 and 420 kg/cm² (D412), tear strength comprised between 105 and 140 kg/cm (D624—die C); modulus 300% comprised between 100 and 145 kg/cm2 (D412); elongation at break comprised between 500 and 650 (%; D412). The PU film is preferably treated to be fireproof and UV-resistant. According to an aspect of the invention, the film material can be filled with fillers able to give particular visual effects, such as for example those obtainable by the addition of powdered mica.

According to a preferred aspect of the invention, the padding, i.e. filling, material comprises a mixture of feathers and down of different origin, such as for example feathers and down of goose and duck, or, alternatively, feathers and down in part of natural origin and in part of synthetic origin. Preferably, the ratio of feathers to down is in the range of 10/90 to 90/10 by weight, preferably in the range of 80/20 to 20/80 and more preferably in the range of 70/30 to 30/70. A preferred ratio, in case of short coats and similar items of clothing, is at least of 30/70.

In one embodiment of the invention, there are provided feathers and down of goose and duck in a ratio goose/duck in the range between 60/40 and 80/20, for example in a ratio of 70/30 by weight. In another embodiment of the invention, there are also provided feathers (and/or down) of different birds, for example there can be feathers of partridge or quail or similar birds.

Preferably, the textile material according to the invention comprises a padding material in which members having at least two, preferably at least three, more preferably at least four, different colours or colour shades are present. In case in which feathers or down having at least two different colors are present, i.e. a part of feathers and down is of a first color and the remaining part is of a second different color, the ratio feathers/down is preferably in the range between 60/40 and 25/75 by weight.

In one embodiment of the invention, feathers and down can be partially undyed, i.e. they still have the natural colors. The padding amount varies according to the usage of the textile material; likewise, in the item of clothing the part formed by the material of the invention varies according to the usage of the item itself. For example, in an item of clothing, the inner layer of the material according to the invention is formed by a down-proof layer (i.e. a barrier to down and feathers), preferably a fabric. This type of fabrics are known in the art and, for example, are formed by yarns suitable or treated for making a barrier effect against the feathers; an suitable material is the polyamide, for example nylon. The inner down proof fabric can be coupled with an additional inner fabric, which will be part of the item of clothing visible inside thereof. In a possible embodiment, the down proof fabric is in part visible through the material of feathers and down; alternatively, the down proof fabric is coupled (on the feather side) with a decorated fabric (for example coloured or having a particular pattern) that is partially visible through the down and feathers.

The invention further concerns an item of clothing which comprises a textile material according to one of the preceding claims, said item of clothing being preferably selected from jackets, coats, short coats, overcoats, purses and handbags.

Another object of the invention is a container or device for at least partially accommodating and protecting objects, in particular portable electronic devices, characterized by comprising a material according to what afore described. Examples of such devices are eyeglass cases and mobile phone cases, USB memory pen, tablets and computers.

In such containers the inner layer is selected from a plastic material and a microfiber material, or a combination thereof. In a preferred embodiment, the inner layer is made of shaped plastic material, preferably for its fitting with the device to be accommodated in the container of the invention. The inner material can be more rigid than the outer material.

Other possible applications can be as an insulating material, for example for wine bottles, cups and similar objects.

### BRIEF DESCRIPTION OF THE DRAWINGS

The invention will now be described in more detail, by way of illustration and not limitation, with reference to the accompanying drawings in which:

FIG. 1 is a schematic cross section of a material according to the invention;

FIG. 2 is a front view of an item of clothing according to the invention; and

FIGS. 3-6 are views of protective containers made of the material according to the invention.

### DETAILED DESCRIPTION OF THE INVENTION

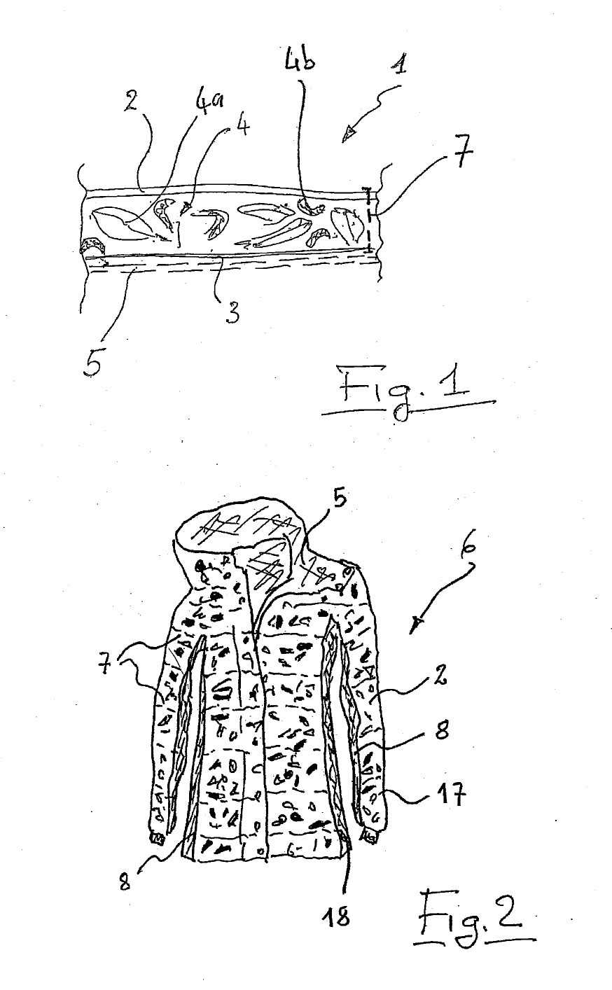

Referring to FIG. 1, the textile material of the present invention is a multilayer textile material 1 comprising at least one outer layer 2, at least one inner layer 3 and a padding, i.e. a filling, material 4 interposed between said two layers 2 and 3. The outer layer 2 is transparent or translucent so that said padding material is at least in part visible through the outer material; the material of the outer layer can be slightly milky. Preferably it is a flexible polyurethane; more preferably it is treated to be fireproof, UV-resistant and antifungal. In addition, the padding material according to the invention is formed by a plurality of elements at least in part having different colours and/or different shades of the same colour.

In FIG. 1, an addition inner layer 5 is shown by dotted lines, such as for example a lining in an item of clothing. The layers 2 and 3 are joined in a known way at predetermined intervals, preferably by seams schematically indicated with the reference numeral 7.

The padding layer can be made of every suitable material, as long as it has at least two different colours or shades of the same colour. In the shown preferred embodiment, the padding material comprises a mixture of feathers and down of different origin. Colours can be different or they can both be of different shades of white.

Furthermore, the padding, i.e. filling, material is preferably obtained from different origin or sources, for example the padding material comprises a mixture of feathers and down of different origin, such as feathers and down of goose and duck, i.e. feathers and down in part of natural original and in part of synthetic origin.

Preferably, the ratio of feathers to down is in the range of 10/90 to 90/10 by weight, within the content of feathers and down, respectively, the amount of feathers or down of duck is in the range of 10% and 30% by weight. Greater details about percentages are given hereinabove and in the dependent claims.

As mentioned, the padding material comprises elements of at least two, preferably at least three, more preferably four or more colors or color shades. Such colors are obtained in a way known in the art.

The textile material of the invention is advantageously used to produce items of clothing preferably selected from jackets, coats, short coats, overcoats, purses and handbags. According to the invention, the outer layer 2 comprises at least in part a transparent plastic film, i.e. said transparent film can be present on at least part of the outer layer 2 only, the remaining part being formed by another material, such as fabric or leather or other materials suitable for the suggested used. Alternatively, whole parts of the final product (item of clothing, furniture element or container) are made of said materials different from the material of the invention, which forms on the contrary the rest of the final product.

FIG. 2 shows a coat 6 made of the material 1 according to the invention; the outer layer 2, the seams 7 and the inner lining 5 are indicated; portions or inserts made of fabric 8 are present along the inner sides of the arms 17 and on the corresponding part 18 of the item body in order to improve the garment wearability and its breathability. In other words, if the item of clothing 6 is a jacket or short coat or similar, there are parts of it that will contact one another as the item is worn, such parts are e.g. inner parts of the sleeves and parts of the item body. In this case, fabric portions are preferably placed in these areas of the outer layer 2 and/or in the place of material 1. In the shown embodiment, said portions of fabric 8 are arranged on at least one of the portions selected from the inner side of the sleeves 17 and portions 18 of the body of the short coat which face said inner side of the sleeves.

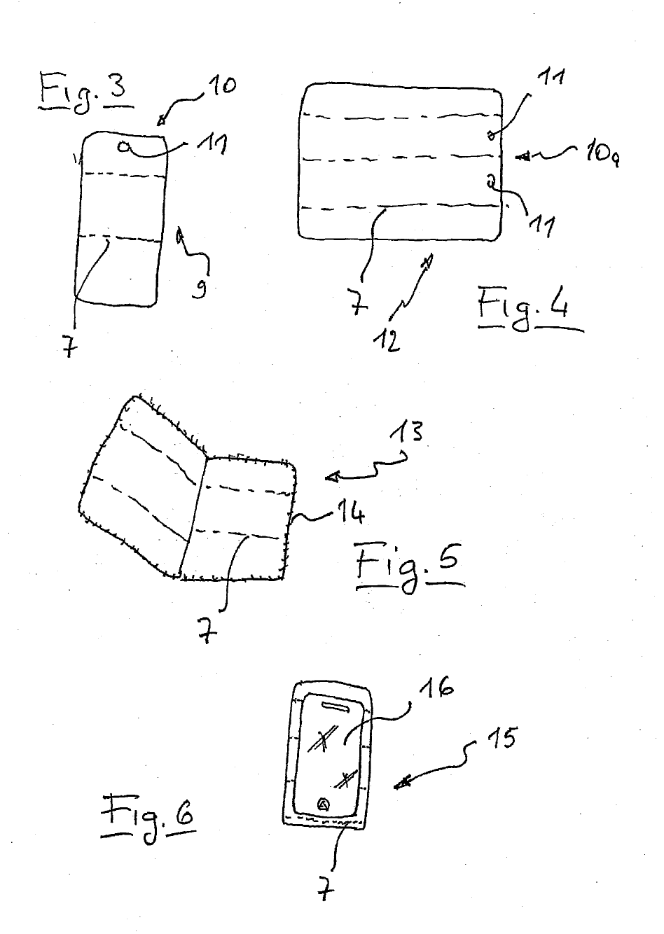

FIGS. 3 and 4 show two protective containers for objects, made of the material of the present invention; in particular FIG. 3 shows a rectangular container 9 provided with an opening 10 re-closable by a button 11, for example suitable for accommodating glasses or mobile phones.

The container 12 of FIG. 4 has an opening 10a closable by two buttons 11 and is suitable to accommodate and protect a computer or tablet.

The same function can be carried out by the container 13, that opens like a book and can be closed, for example, by a zip 14 or similar means like Velcro. In FIG. 6 the container 15 has a part that is missing on one of the sides in order to get to the mobile phone 16 accommodated therein.

According to the application type, the inner layer 3 can be made of fabric, for example nylon for the coat 6, or a plastic material more or less rigid, or more or less elastic, for different applications. The presence of an inner layer made of plastic material is particularly useful when the possibility of adjusting the impact resistance of the container of the invention is needed.

1. Multilayer textile material, comprising an outer layer, at least one inner layer and a padding material interposed between said outer layer and said at least one inner layer, wherein said outer layer is at least partially transparent or translucent and said padding material is formed of a plurality of members at least partially having different colours and/or different shades of the same colour, said padding material being at least partially visible through said outer layer.

2. The multilayer textile material according to claim 1, wherein said outer layer is made of polyurethane.

3. The multilayer textile material according to claim 2, wherein said polyurethane has a thickness between 100 and 200 microns.

4. The multilayer textile material according to claim 1, wherein at least part of said outer layer includes pigments or mineral fillers.

5. The multilayer textile material according to claim 1, wherein said padding material comprises a mixture of feathers and down of different origin.

6. The multilayer textile material according to claim 5, wherein a ratio of feathers to down is in the range of 10:90 to 90:10 by weight.

7. The multilayer textile material according to claim 5, wherein the ratio of feathers to down is in the range of 70:30 to 30:70.

8. The multilayer textile material according to claim 1, wherein said padding material includes said members having at least four different colours or colour shades.

9. Item of clothing comprising said multilayer textile material according to claim 1, said item of clothing comprising one of a jacket, a coat, a short coat, and an overcoat.

10. The item of clothing according to claim 9, wherein said padding material has a ratio of feathers to down of at least 30:70.

11. The item of clothing according to claim 10, further comprising one or more fabric portions disposed on the outer layer.

12. The item of clothing according to claim 11, wherein said item of clothing is a jacket or short coat and said fabric portions are arranged on at least one of an inner side of sleeves and portions of a body of the short coat which face said inner side of the sleeves.

13. Container device for containing and at least partially protecting portable electronic devices, comprising the multilayer textile material according to claim 1.

14. The container device according to claim 13, wherein said at least one inner layer is formed of a plastic material, a microfiber material, or a combination thereof.

15. The container device according to claim 13, wherein said at least one inner layer is a shaped plastic material.

16. The multilayer textile material according to claim 2, wherein said polyurethane comprises polyether polyurethane.

17. The multilayer textile material according to claim 2, wherein said polyurethane has a thickness between 130 and 150 microns.

18. An item comprising one of a purse and a handbag formed of said multilayer textile material according to claim 1.
